(19) United States
(12) Patent Application Publication
(10) Pub. No.: US 2009/0054067 A1
(43) Pub. Date: Feb. 26, 2009

(54) SYSTEM AND METHOD FOR GESTURE-BASED COMMAND AND CONTROL OF TARGETS IN WIRELESS NETWORK

(75) Inventors: Claude Gauthier, Richelieu (CA); Martin Kirouac, Brossard (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/843,966

(22) Filed: Aug. 23, 2007

(51) Int. Cl. H04Q 7/20

(52) U.S. Cl. 455/440

(57) ABSTRACT

A method and apparatus to identify a remote target in a local wireless network and provide at least one command to the identified remote target. The remote target is identified and commanded or controlled by moving a device through a sequence of first and second movements. These movements may form a part of a gesture language set. The first movement may be carried out by pointing the device toward the remote target device to identify the remote target. If the second movement corresponds with at least one movement characteristic associated with a command, the command is provided to the identified remote target.

### BACKGROUND

The present invention relates to gesture recognition in electronic equipment, and more particularly to methods and apparatuses for directing a target device based on a recognized gesture.

In today's wireless world, communication is carried out using devices such as mobile phones, desktops, laptops and handhelds to convey information. These devices communicate voice, text and image information by using interfaces such as a microphone, keyboard, notepad, mouse or other peripheral device. While communication technology has developed to a high level, little attention is paid to non-verbal body language, which has been used since time immemorial to communicate information between individuals or groups.

Around the world, gestures play an integral part of communication within every culture. Gestures can communicate as effectively as words, and even more so in some contexts. Examples of gestural language can be seen in traffic police, street vendors, motorists, lecturers, a symphony conductor, a couple flirting, a restaurant patron and a waiter, and athletes and their coaches. It is amazing what the body can communicate expressively and how easily the mind of the observer can almost instinctively process this vocabulary of gestures.

While body-expressed communication is said to account for most communication among humans, current communication technologies make little use of this powerful form of expression.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with some embodiments of the invention, a method identifies a remote target and provides at least one command to the identified remote target. The remote target is identified by moving a device a first time, and identifying a target based on the first movement. The device is moved a second time, and a determination is made as to whether the second movement corresponds with at least one movement characteristic associated with a command. The associated command is transmitted to the identified remote target.

In accordance with another aspects of the invention, a mobile unit includes a processor, a transceiver coupled to the processor and configured to receive location information about a remote target device in the local area network, a location determining unit coupled to the processor and configured to determine a location of the mobile unit, and a sensing unit coupled to the processor. The sensing unit includes a movement sensing circuit that is configured to sense movement of the sensing unit, and a direction sensing circuit configured to sense a heading of the sensing unit. The processor is configured to identify the remote target device based on a heading sensed by the direction sensing circuit, a first movement sensed by the movement sensing circuit, and location information about the remote target device and mobile unit.

### BRIEF DESCRIPTION OF THE DRAWINGS

The objects and advantages of the invention will be understood by reading the following detailed description in conjunction with the drawings in which:

FIG. 1a is a diagram of wireless network system in accordance with an exemplary embodiment.

FIG. 1b is a schematic block diagram of an exemplary controlling unit in accordance an embodiment of the invention.

FIG. 2 is a block diagram of an exemplary movement direction and location sensing unit.

FIG. 3 is a diagram that illustrates reference frames associated with some exemplary embodiments.

FIG. 4 is a diagram that illustrates a result of separate commands transmitted from a mobile unit to a plurality of receiving units in accordance with an exemplary embodiment.

FIG. 5 is a diagram of an embodiment illustrating an exemplary embodiment of moving and pointing a direction sensing device to identify a targeted mobile unit.

FIG. 6 is a schematic block diagram of wireless communication system in accordance with an exemplary embodiment.

FIG. 7 is a diagram of an exemplary suit including sensors and illustrating various pointing angles.

FIG. 8 is a diagram of a glove including sensing devices in accordance with an exemplary embodiment.

FIG. 9 is an illustration of exemplary hand and/or body gestures that may be included in a language set.

FIG. 10 is a schematic diagram illustrating network-based applications in accordance with exemplary embodiments.

FIG. 11 is a flowchart illustrating operations for providing at least one command to a remote target according to an embodiment.

### DETAILED DESCRIPTION

The various features of the invention will now be described with reference to the figures. These various aspects are described hereafter in greater detail in connection with a number of exemplary embodiments to facilitate an understanding of the invention, but should not be construed as limited to these embodiments. Rather, these embodiments are provided so that the disclosure will be thorough and complete, and will fully convey the scope of the invention to those skilled in the art.

Many aspects of the invention are described in terms of sequences of actions to be performed by elements of a computer system or other hardware capable of executing programmed instructions. It will be recognized that in each of the embodiments, the various actions could be performed by specialized circuits (e.g., discrete logic gates interconnected to perform a specialized function), by program instructions being executed by one or more processors, or by a combination of both. Moreover, the invention can additionally be considered to be embodied entirely within any form of computer readable carrier, such as solid-state memory, magnetic disk, optical disk or carrier wave (such as radio frequency, audio frequency or optical frequency carrier waves) containing an appropriate set of computer instructions that would cause a processor to carry out the techniques described herein. Thus, the various aspects of the invention may be embodied in many different forms, and all such forms are contemplated to be within the scope of the invention.

In an aspect of embodiments consistent with the invention, gesture language is used as a new way to communicate in a wireless network. Exemplary embodiments involve using gestural actions to identify, command and/or control one or more targets in a wireless network. For example, a wireless network may include one or more wireless units that receive directives or other information based on body language conveyed by another wireless unit. Other exemplary embodiments may include gestural identification and control of a target device in a wireless network.

Embodiments according to the present invention are described with reference to block diagrams and/or operational illustrations of methods, mobile units, and computer program products. It is to be understood that each block of the block diagrams and/or operational illustrations, and combinations of blocks in the block diagrams and/or operational illustrations, can be implemented by radio frequency, analog and/or digital hardware, and/or computer program instructions. These computer program instructions may be provided to a processor circuit of a general purpose computer, special purpose computer, ASIC, and/or other programmable data processing apparatus, such that the instructions, which execute via the processor of the computer and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

As used herein, a “mobile unit” includes, but is not limited to, a device that is configured to receive communication signals via a wireless interface from, for example, a cellular network, a Wide Area Network, wireless local area network (WLAN), a GPS system, and/or another RF communication device. A group of mobile units may form a network structure integrated with other networks, such as the Internet, via cellular or other access networks, or as a stand alone ad-hoc network in which mobile units directly communicate with one another (e.g., peer-to-peer) through one or more signal hops, or combination thereof. Examples of ad-hoc networks include a mobile ad-hoc network (MANET), a mobile mesh ad-hoc network (MMAN), and a Bluetooth-based network, although other types of ad-hoc networks may be used. Exemplary mobile terminals include, but are not limited to, a cellular mobile terminal; a GPS positioning receiver; a personal communication terminal that may combine a cellular mobile terminal with data processing and data communications capabilities; a personal data assistance (PDA) that can include one or more wireless transmitters and/or receivers, pager, Internet/intranet access, local area network interface, wide area network interface, Web browser, organizer, and/or calendar; and a mobile computer or other device that includes one or more wireless transmitters or receivers.

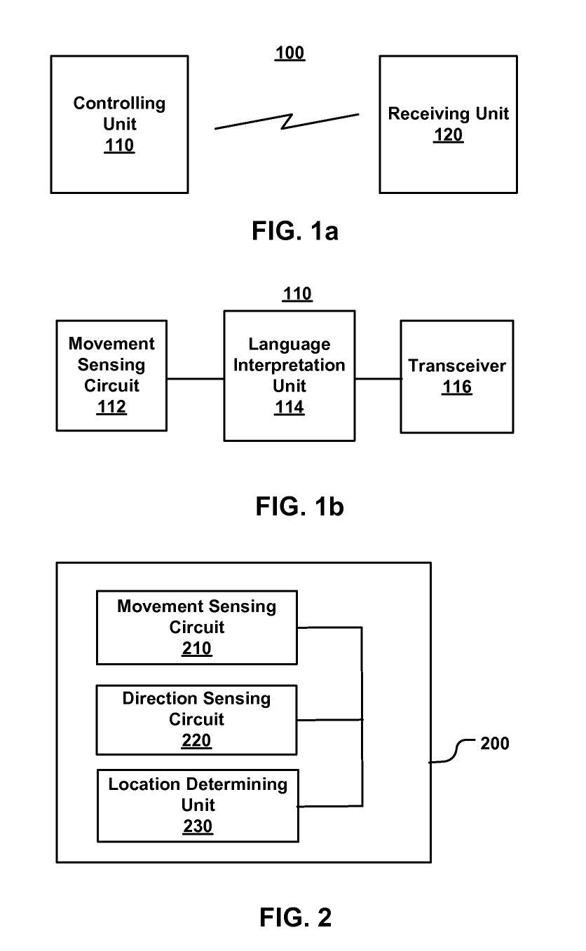

FIG. 1a is a diagram of wireless network system 100 in accordance with an embodiment of the invention. Wireless network system 100 may include a controlling unit 10 and a receiving unit 140 located remotely from the controlling unit 10. In some embodiments, the controlling unit 110 may be a mobile unit provided with at least one sensor that may detect a series of movements, such as movement of all or part of the controlling unit 110 or a gesture performed by a user of the controlling unit, and distinguish between first and second movement events that respectively identify the targeted receiving unit 120 and command the identified receiving unit 120 to do something. In other embodiments, the controlling unit 110 may be a fixed network device (e.g., a computer) located at a node of a wired or wireless network, which may communicate wirelessly with a receiving unit 120 either directly or through an access system (e.g., cellular, WLAN or mesh networks) to identify and control that unit.

FIG. 1b is a schematic block diagram of the controlling unit 110 according to an embodiment. The controlling unit 110 may include a movement sensing circuit 112 connected to a language interpretation unit 114 by way of a wired or wireless link. The language interpretation unit 114 may include programs that instruct the processor to determine whether an event corresponds to a first movement identifying the receiving unit 120 or a command to be transmitted to the receiving unit 120, although all or some of functions of detecting and determination may performed with hardware.

The language interpretation unit 114 may identify movements corresponding to elements, or a combination of movements corresponding to a plurality of elements, of a predetermined gestural language set of the network system 100. The gestural language set may include as little as one identification movement and/or one command movement, or as many movements the language interpretation unit 114 is capable of distinguishing and interpreting. Generally, the granularity of the gestural language set corresponds to the precision required for sensing a movement and reliable interpretation of that movement.

The receiving unit 120 may be a fixed device or another mobile unit similar to the controlling unit 10. The receiving unit 120 includes a receiver, which may receive signals transmitted from the controlling unit directly or through one or more hops in a local network in a local network (e.g., some WLANs, Bluetooth (BT), MANET), and/or through a wireless access point (e.g., WLAN, cellular or mesh), such as radio network accesses using protocols such as Global Standard for Mobil (GSM) communication Base Station System (BSS), General Packet Radio Services (GPRS), enhanced data rates for GSM evolution (EDGE), code division multiple access (CDMA), wideband-CDMA (WCDMA), although other wireless protocols may be used.

The movement sensing circuit 112 may include one or more sensors, such as an accelerometer, gyroscope, touch pad and/or flex sensor, although other sensors capable of detecting movement may be used. Such sensors may be integrated within, or provided in a peripheral manner with respect to the controlling unit 110. It should be appreciated, however, that a “sensing circuit,” as used herein, may include only one sensor, or a plurality of sensors and related circuitry arranged in a distributed fashion to provide movement information that may be utilized individually or in combination to detect and interpret elements of the gestural language set. In some embodiments, a user of a mobile unit may initiate a movement event in which sensing circuit 112 receives a plurality of movement language elements provided in a consecutive manner, which identify and command the receiving unit 120. In such a case, the processor may parse the movement event into separate language elements to carry out sequential processing of the elements. In other embodiments, the controlling unit 110 may operate in a mode that will accept a command movement only after receiving acknowledgement from the identified receiving unit 120.

Embodiments of the invention may include a sensor to measure a direction associated with the first movement to identify a particular receiving unit 120. This added dimension is particularly useful when more than one receiving unit 120 is located in proximity of the controlling unit 110. Such embodiments may include a sensing unit 200 shown in block form in FIG. 2. Sensing circuit 200 includes a movement sensing circuit 210, a direction sensing circuit 220, and a location determining unit 230. The movement sensing circuit 210 may include one or more inertial measurement units, such as accelerometers or gyroscopes, although other inertial sensors may be used. The direction sensing circuit 220 may include a direction sensing device, such as an electronic compass, to provide a heading associated with a movement performed by a user of the controlling unit 110 to identify a particular receiving unit 120. The location determining unit 230 includes a location-determining device, such as Global Positioning System (GPS) receiver.

In exemplary embodiments, the heading information may be obtained by pointing a controlling unit 110 in the direction of a receiving unit 120. As used herein, “pointing” may involve a controlling unit 110 that has a direction sensor provided inside a single outer package of the device (e.g., a PDA, cell phone) and moving the entire device a particular way to point it at the target. Alternatively, a direction sensing device may be provided in a peripheral manner with respect to other components of the controlling device 110 (e.g.. attached to an article of clothing, a body part of the user, a hand-held pointing device, baton, or other manipulable element), and performing a movement to initiate a process of providing a command to a target unit simultaneously with pointing the direction sensor. For example, an embodiment may identify a target by sensing a movement in which an arm is extended fully outward, and a direction sensor attached to the arm, sleeve, finger or glove and oriented along the lengthwise axis of the extended arm, senses the relative direction of the extended arm. In some embodiments, reading a heading may involve moving one body part while pointing with another body part, or performing a sequence of movements (e.g., gesture followed by pointing the direction sensor at the target). However, certain movements may be defined within the gestural language set that would initiate a broadcast command to all receiving devices in the wireless network without utilizing a direction sensor.

As described hereinafter in more detail, the orientation of elements of a direction sensor may provide information permitting calculation of a heading relative to the sensor's orientation. Using the calculated heading to the receiving unit 120, the location information of the controlling unit 110 and receiving unit 120 (e.g., determined via the GPS), the receiving unit 120 may be identified as potential target.

The GPS uses a constellation of 24 satellites orbiting the earth and transmitting microwave band radio frequencies across the globe. GPS receivers capture at least 4 of the satellite transmissions and use difference in signal arrival times to triangulate the receiver's location. This location information is provided in the classic latitude (north-south) and longitude (east-west) coordinates given in degrees, minutes and seconds. While various embodiments of the invention described herein with reference to GPS satellites, it will be appreciated that they are applicable to positioning systems that utilize pseudolites or a combination of satellites and pseudolites. Pseudolites are ground-based transmitters that broadcast a signal similar to a traditional satellite-sourced GPS signal modulated on an L-band carrier signal, generally synchronized with GPS time. Pseudolites may be useful in situations where GPS signals from orbiting GPS satellites might not be available, such as tunnels, lines, buildings or other enclosed areas. The term “satellite,” as used herein, is intended to include pseudolites or equivalents of pseudolites, and the term GPS signals, as used herein, is intended to include GPS-like signals from pseudolites or equivalents of pseudolites. Also, while the following discussion references the United States GPS system, various embodiments herein can be applicable to similar satellite positioning systems, such as the GLONASS system or GALILEO system. The term “GPS”, as used herein, includes such alternative satellite positioning systems, including the GLONASS system and the GALILEO system. Thus, the term “GPS signals” can include signals from such alternative satellite positioning systems.

Direction may be sensed by a two-axis electronic compass, which measures the horizontal vector components of the earth's magnetic field using two sensor elements in the horizontal plane but orthogonal to each other. These orthogonally oriented sensors are called the X-axis and Y-axis sensors, which measure the magnetic field in their respective sensitive axis. The arc tangent Y/X provides the heading of the compass with respect to the X-axis. A two-axis compass can remain accurate as long as the sensors remain horizontal, or orthogonal to the gravitational (downward) vector. In some mobile embodiments, two-axis compasses may be mechanically gimbaled to remain flat and ensure accuracy. Other embodiments may include a three-axis magnetic compass, which contains magnetic sensors in all three orthogonal vectors of an electronic compass assembly to capture the horizontal and vertical components of the earth's magnetic field. To electronically gimbal this type of compass, the three magnetic sensors may be complemented by a tilt-sensing element to measure the gravitational direction. The tilt sensor provides two-axis measurement of compass assembly tilt, known as pitch and roll axis. The five axis of sensor inputs are combined to create a “tilt-compensated” version of the X-axis and Y-axis magnetic vectors, and then may be computed into a tilt-compensated heading.

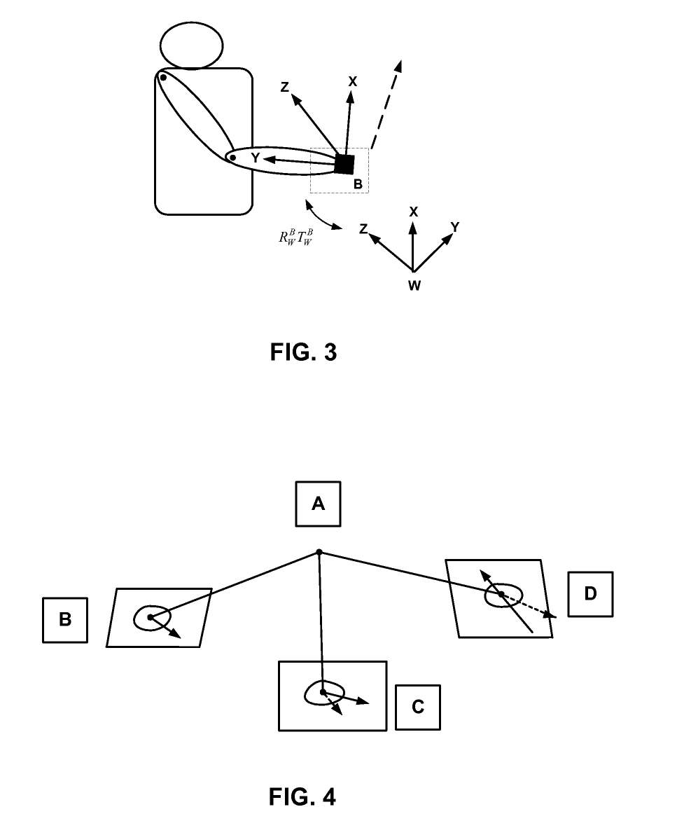

FIG. 3 is a diagram illustrating a reference frame B at the end of a forearm. Sensors may be provided on the forearm to detect and track movements of the arm. For example, a gyroscope device provided on or over the cuff area will move in the same motion as the arm angular movement of an arm as it moves tip to down and left to right. The gyroscope may be of one or two axis design. Similarly, one, two or three axis acceleration sensors (e.g., accelerometers) may be positioned on or about the arm to obtain acceleration data useful for determining movements involving translation. However, an important consideration is the lack of an absolute reference frame and the difficulty of tracking orientation relative to a fixed frame for longer than a few seconds. Therefore, in some embodiments of the invention, an electronic compass is attached to the body to provide a reference frame.

Information output from the movement sensors, the electronic compass, and a GPS receiver may be analyzed to determine whether a user performed one or more gestures to identify and command a target in the wireless network. For example, FIG. 4 shows how gesture-based language may be used in a local wireless network to individually target and command mobile units. As shown FIG. 4, a mobile unit A points to a mobile unit B and performs a gesture that commands B to “move forward” (e.g., a hand direction). Commands received by B (or any other mobile target) may be played back as a voice and/or text message. Only mobile unit B receives and processes this message. Next, mobile unit A points to a mobile unit D and commands D to “move back.” Again, only mobile unit D would be receiving this information. Next, mobile unit A points to a mobile unit C and commands C to “move forward.” All movement of mobile units B, C and D may be collected and mobile unit A is informed of all new positions.

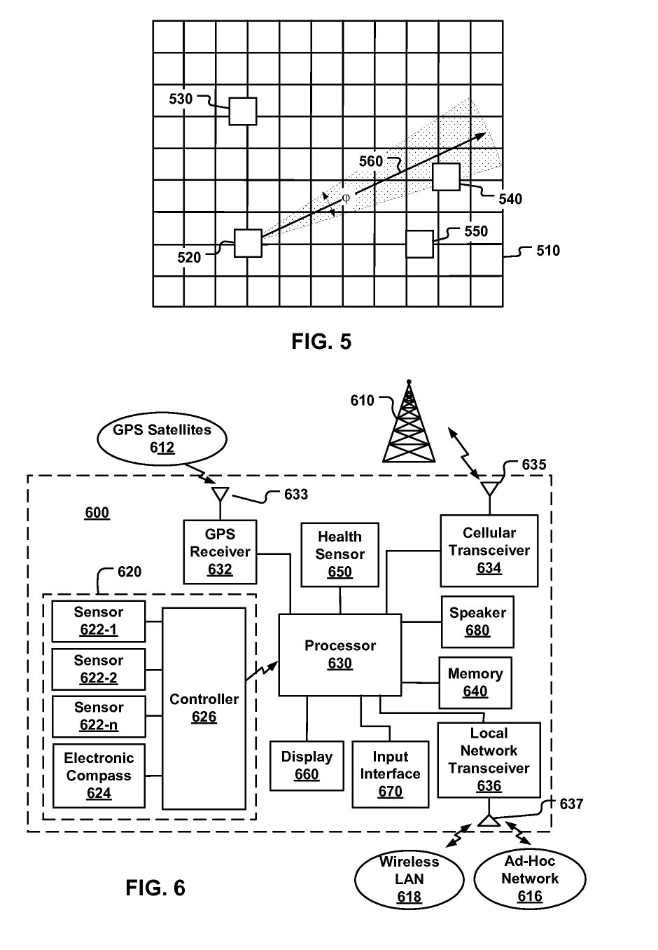

FIG. 5 is a diagram of an embodiment illustrating how a “pointing” movement may identify a target (e.g., a receiving mobile unit). For purposes of explanation, FIG. 5 includes a grid 510, which may represent increments in longitude and latitude or some other spatial value. In some embodiments, elements 520, 530, 540 and 550 may represent mobile units (e.g., a controlling units or receiving units) at locations in a wireless network, although the position of an identifiable target may be fixed at a particular location. Mobile unit 520 may operate in the controlling unit mode to identify and command mobile unit 540, and include a movement sensing circuit, a direction sensing circuit, and a location determining unit as described above. Additionally, the mobile wireless unit 520 may be aware of the locations of mobile units 530, 540 and 550 by sight, or by way of reference to a screen displaying their respective positions. For example, each of the mobile units may upload position data (e.g., determined from GPS) to a server at regular intervals. The mobile unit 520 may download the data at regular intervals to track movement of mobile units with reference to a local map including a layer showing the positions of each mobile unit 530, 540 and 550. This information may be provided as a map display or another type of graphical object.

To initiate identification of mobile unit 540, the user of the mobile device 520 may point the direction sensor (e.g., an electronic compass) in the direction of the mobile unit 540. The heading provided by the direction sensor is shown by arrow 560. Because pointing the electronic compass toward the receiving unit may involve imprecise dead reckoning by the user, some embodiments find and identify a mobile unit nearest to the heading. Also, consideration of candidates may be limited to an area local to the heading, for example, a sector 570 of angle φ and centered about the heading 560. In some embodiments, more than one potential candidate may be identified based on a sensed heading, for example, a heading that is near both units 550 and 540. For instance, both mobile units 550 and 540 may receive a target request from mobile unit 520 and return target positioning information back to mobile unit 520 (e.g., via a network server or communication links between mobile units within the local network). Mobile unit 520 may then identify the desired target by selecting either mobile unit 550 or 540 based on the position information received from these units, such as selecting a graphical position or performing movement to select from among the potential candidates.

To direct the identified mobile unit 540, the user of mobile unit 520 performs a movement (e.g., a body and or hand gesture) subsequent to movement for identifying the mobile unit 540. The mobile unit 520 interprets the subsequent movement, establishes communication with mobile unit 540 over a wireless network (e.g., through a local network, a cellular network or other network resource) and transmits a directive or other information to the mobile unit 540. Hence, even if a mobile unit cannot view the intended recipient (e.g. the intended recipient is blocked by an obstacle), members of a local wireless network group may identify and direct that mobile unit.

FIG. 6 is a schematic block diagram of an exemplary wireless communication system that includes a mobile unit 600. As shown in FIG. 6, mobile unit 600 receives wireless communication signals from a cellular base station 610, GPS satellites 612, and a gesture and sensing unit 620. The cellular base station 610 may be connected to other networks (e.g., PSTN and the Internet). The mobile terminal 600 may communicate with an Ad-Hoc network 616 and/or a wireless LAN 618 using a communication protocol that may include, but is not limited to, 802.11a, 802.11b, 802.11e, 802.11g, 802.11i, Bluetooth (BT), MMAN, MANET, NWR and/or other wireless local area network protocols. The wireless LAN 618 also may be connected to other networks (e.g., the Internet).

In some embodiments of the invention, the gesture sensing unit 620 includes sensors 622-1 to 622-n, which may be one or more an acceleration measurement sensor (e.g., accelerometer(s)), gyroscope, bend flex sensors, and a directional sensor 624, which is an electronic compass in this embodiment. While the embodiment of FIG. 6 depicts a plurality of sensors 622, it may include as little as one movement sensor. The sensor(s) and the electric compass 624 are connected a controller 626, which may communicate with a processor 630 via a wired or RF radio links. Also connected to the processor is a GPS receiver 632, a cellular transceiver 634, and local network transceiver 636 with respective antennae 633, 635 and 637, a memory 640, a health sensor 650 (e.g., pulse, body temperature, etc.), a display 660, an input interface 670 (e.g., a keypad, touch screen, microphone etc. (not shown)), and an optional speaker 680. The GPS receiver 632 can determine location based on GPS signals that are-received via an antenna 633. The local network transceiver 636 can communicate with the wireless LAN 618 and/or Ad-Hoc network 616 via antenna 637.

The memory 640 stores software that is executed by the processor 630, and may include one or more erasable programmable read-only memories (EPROM or Flash EPROM), battery backed random access memory (RAM), magnetic, optical, or other digital storage device, and may be separate from, or at least partially within, the processor 630. The processor 630 may include more than one processor, such as, for example, a general purpose processor and a digital signal processor, which may be enclosed in a common package or separate and apart from one another.

The cellular transceiver 634 typically includes both a transmitter (TX) and a receiver (RX) to allow two-way communications, but the present invention is not limited to such devices and, as used herein, a “transceiver” may include only a receiver. The mobile unit 600 may thereby communicate with the base station 610 using radio frequency signals, which may be communicated through the antenna 635. For example, the mobile unit 600 may be configured to communicate via the cellular transceiver 634 using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS). Communication protocols, as used herein, may specify the information communicated, the timing, the frequency, the modulation, and/or the operations for setting-up and/or maintaining a communication connection. In some embodiments, the antennas 633 and 635 may be a single antenna.

In other embodiments, the gesture sensing unit 620 may be provided in jewelry (e.g., one or more rings, a wristwatch) or included with any type of device or package that can be attached (e.g., by adhesive, strap), worn, held or manipulated by the body.

Returning to FIG. 6, although the gesture sensing unit 620 is depicted as a wireless sensing device, it should be appreciated that in other embodiments a gesture sensing unit may be wired to a processor. For example, a gesture sensing unit may be wired to a processor located within a suit, glove, jewelry or other device or package (e.g., both the gesture sensing unit and processor may be located within a handheld device package or casing, such as a PDA), or the processor may be located remotely with respect to the gesture sensing unit and wires provided therebetween (e.g., between a mouse including a gesture sensing unit and a computer including a processor).

Additionally, embodiments of the controlling unit 10 shown in FIG. 1a may include a device having a fixed location. For example, the controlling unit 110 may be a computer located at any node in a network (e.g., a WAN, LAN or WLAN). An operator of the controlling unit 110 may identify and command one or more remote wireless targets based on viewing representations of the targets on a display (e.g., computer display, PDA display, table-top display, goggle type display). In some embodiments, movement sensing to identify and/or command a remotely deployed wireless target may involve interacting with a display, for example, a touch screen display that may be manipulated at a position corresponding to the displayed remote wireless target. In other embodiments, the reference frame of the operator's gestures sensed by the gesture sensing unit may be translated to the reference frame of the displayed remote wireless targets such that the operator is virturally located near the remote wireless targets. Hence, embodiments may include a computer operator manipulating a movement sensing unit (e.g., a glove, display, handheld device) while viewing a screen to identify and control one or more mobile and or fixed wireless target devices deployed remotely from the operator.

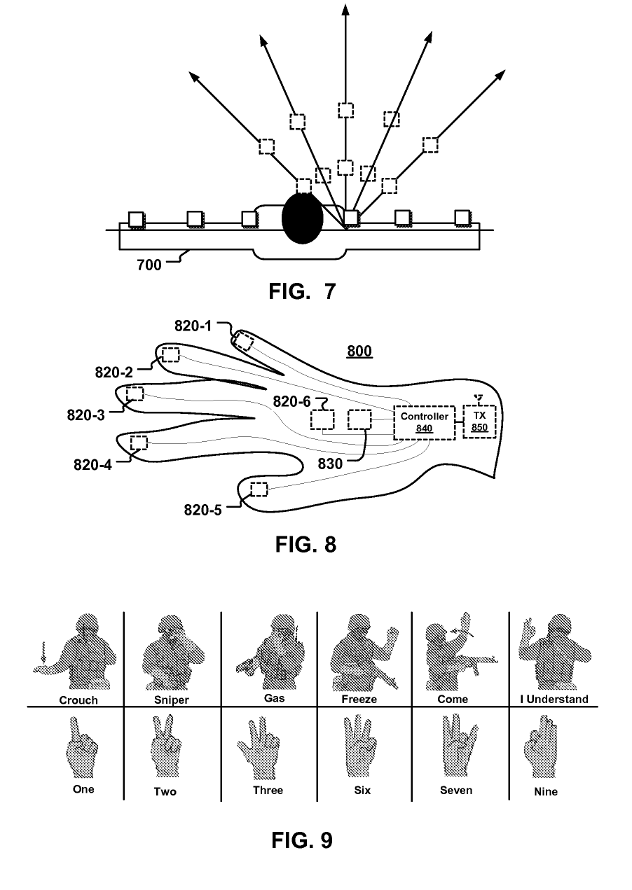

FIG. 7 shows a top view of an embodiment in which a user wears a suit, shirt, jacket or other garment 700 that includes at least one movement sensing device, such as accelerometers and/or gyroscopes. FIG. 7 also illustrates a sweep of exemplary headings extending from the shoulder of the user, which represent pointing directions that may be sensed by a direction sensor provided on the sleeve of the garment 700.

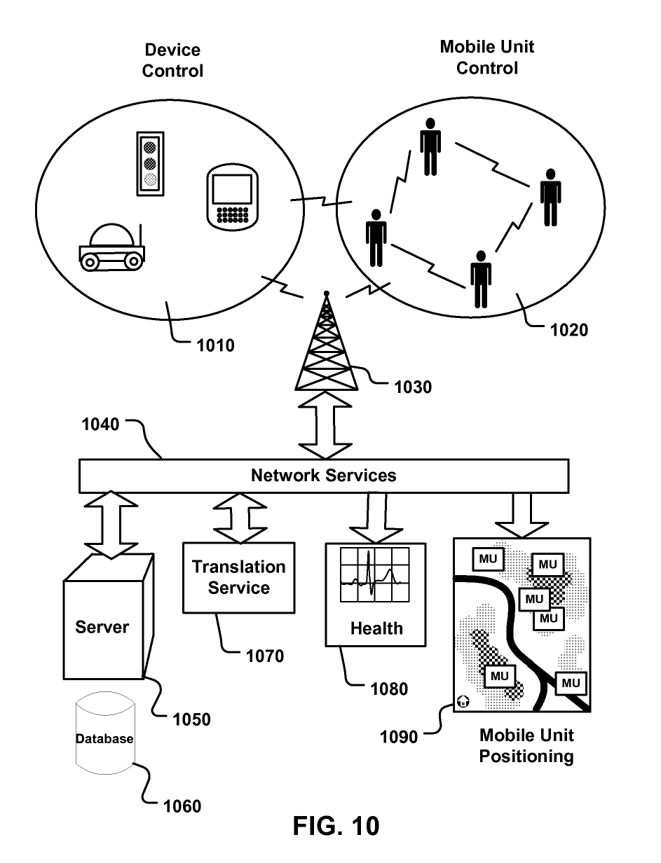

FIG. 8 is a diagram of a glove 800 in accordance with exemplary embodiments. The glove 800 corresponds to the gesture sensing unit 620 depicted in the exemplary embodiments shown in FIG. 6. The glove 800 may provide a significant increase in the granularity and amount of determinable commands of a gestural language set. For instance, a gestural language set may include “hand signals,” such as the partial list of military signals depicted in FIG. 9. The glove 800 also may be used to interpret sign languages, such as American Sign Language (ASL) and British Sign Language (BSL). The glove 800 may include one or more movement sensors 820-1 to 820-5 provided on each finger and on the thumb to sense angular and translational movement the individual digits, groups of digits and/or the entire glove. To provide additional movement information, at least one movement sensor 820-6 may be provided on the back of the palm or elsewhere on the glove 800, although the sensors may be provided at other locations on the glove. The movement sensors 820-1 to 820-6 may include accelerometers, gyroscopes and/or flex sensors, as described above. The glove 800 also includes a direction sensing device 830, such as electric compass, which may be oriented in a manner that provides efficient of target discrimination and/or gesture detection and interpretation. Flexible links may be provided to connect the movement sensors 820-1 to 820-6 and direction sensor 830 to a controller 840, which provides serial output to an RF transmitter 850 (e.g., via BT protocol), although the output from controller 840 may be transmitted via wired or wireless link to a processor (e.g., processor 630 in FIG. 6). The sensors on the glove 800 generate signals from the movement, orientation, and positioning of the hand and the fingers in relation to the body. These signals are analyzed by a processor to find the position of the fingers and hand trajectory and determine whether a gesture or series of gestures performed correspond with elements of the gesture language set. FIG. 10 is a schematic diagram illustrating network-based applications in accordance with exemplary embodiments. FIG. 10 shows an exemplary set of devices 1010 that may be identified and controlled via gesture movements, as described herein. Also shown is a set of mobile units 1020, each of which may be members of a peer-to-peer based wireless local network, such as WLAN, a Mobile Mesh Ad-Hoc network (MMAN), a Mobile Ad-Hoc network (MANET), and a Bluetooth-based network. The radio controllable devices 1010 also may communicate locally with the mobile units 1020 within the local wireless network. The devices 1010 and mobile units 1020 may have access to network services 1040 through base station 1030.

For purposes of brevity, FIG. 10 shows a limited number of exemplary applications and network services that are possible with embodiments of the invention. These examples include server 1050 and database 1060 the devices 1010 and/or mobile units 1020 may transmit and receive information; a translation service 1070 that may provide services for map and coordinate translation (e.g., a GIS server), a health monitoring service 1080, which may track the heath of the mobile units and or provide displayable information; and a mobile unit positioning application 1090 which tracks the position of mobile units in a local wireless network and provides a graphical view (e.g., positions displayed on a local topographical map) to the mobile units or other location(s) remote from the wireless network (e.g., a command center).

Gesture based wireless communication may be applied in a variety of ways. For instance, a police officer may remotely control traffic lights using hand and or arm gestures to change the light according to a gesture. In another embodiment, a firemen controller may receive, on display, the location of each fireman and provide individual and precise commands. Small army troops, commandos, a SWAT team, and a search and/or rescue team may deploy local wireless networks to selectively communicate among themselves or other devices connectable to the wireless network (e.g., robots or other machinery), and provide the network members with vital location data, health data and directives. Other group or team applications may include recreational strategic games, where players can deploy a local wireless network to communicate and instruct among selected players.

There are many other possible applications. Some embodiments involve selection and control of spatially fixed equipment (e.g., selecting one screen among many screens and controlling a camera associated with that screen to pan, zoom in/out etc.), adjust settings of fixed equipment (e.g., volume on a stereo, pressure in a boiler, lighting controls, security mechanisms, engine/motor rpm), and so on.

Exemplary applications also may include mobile phones or other portable devices that incorporate movement sensors, a location determining device, and a direction sensor to perform control multimedia applications. For example, the direction and directive functions of such a portable device may be interpreted as a video game console or utilized to select an icon displayed in a video presentation and activate that icon. In an embodiment, a portable device may be used to control and send commands in a casino games (e.g., virtually turning a wheel or pulling a level on a screen, send commands to continue, reply etc.).

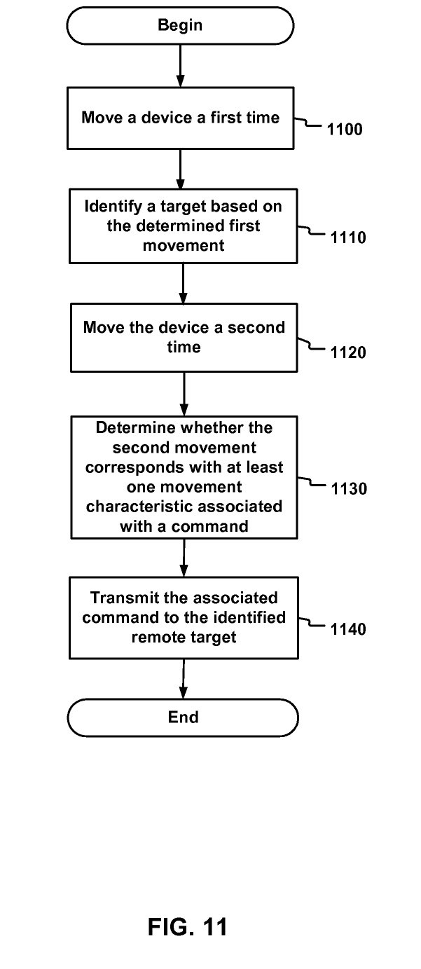

FIG. 11 is a flowchart illustrating operations for providing at least one command to a remote target according to some other embodiments. The operation begins at process block 1100 in which a device is moved a first time to identify a remote target. For example, a remote target may be identified by pointing a direction sensing device at the remote target. Some embodiments may include a determination as to whether the first movement corresponds to an identification directive. For example, it may be determined that the first movement corresponds to a pointing movement or other gesture defined in a predetermined gestural language set. In process 1110, a target is identified based on the determined first movement. The device is moved a second time in process 1120. Process 1130 determines whether the second movement corresponds with at least one movement characteristic associated with a command. If the second movement is matched or otherwise recognized to correspond with at least one movement characteristic associated with a command, the command is transmitted to the identified target in process 1140. For example, gesture samples may be stored in a database and linked to commands. Methods of recognizing gestures may include a matching algorithm that identifies a gesture when a sufficient amount of correlation between sensed movement and stored sample data exists, or other methods such as a trained neural network. Signals relating to incidental movement or other sources of movement noise also may be filtered out to prevent activating complete gesture recognition of (e.g., walking).

The invention has been described with reference to particular embodiments. However, it will be readily apparent to those skilled in the art that it is possible to embody the invention in specific forms other than those of the embodiment described above. The described embodiments are merely illustrative and should not be considered restrictive in any way. The scope of the invention is given by the appended claims, rather than the preceding description, and all variations and equivalents that fall within the range of the claims are intended to be embraced therein.

What is claimed is:

1. A method of providing at least one command to a remote target device in a local wireless network, comprising:
moving a device a first time;
identifying a target device based on the determined first movement;
moving the device a second time;
determining whether said second movement corresponds with at least one movement characteristic associated with a command; and
transmitting the associated command to the identified remote target device.

2. The method of claim 1, wherein the at least one movement characteristic corresponds to a gesture.

3. The method of claim 2, wherein each of a plurality of commands is respectively associated with one or more different movement characteristics, and said determination is based on recognizing which of the different movement characteristics corresponds with the second movement.

4. The method of claim 1, wherein the first movement comprises a pointing gesture.

5. The method of claim 1, further comprising determining a heading from the device to the remote target device.

6. The method of claim 1, wherein the device is a mobile wireless unit.

7. The method of claim 6, further comprising determining a location of the device.

8. The method of claim 1, further comprising sensing the first and second movements to generate signals corresponding to gestural movement.

9. The method of claim 8, wherein the gestural movement comprises a hand signal.

10. The method of claim 1, wherein the first and second movements generate signals corresponding to sensed acceleration.

11. The method of claim 1, wherein the transmitted command comprises at least one of data relating to a text message for display by the target device, data relating to an audio message to be played by the target device, and data for controlling the target device.

12. The method of claim 1, wherein transmitting the command comprises a peer-to-peer transmission.

13. The method of claim 1, further comprising:
determining a location of the device based on GPS signals received from a plurality of space based satellites,
receiving location information of at least one other device in the local wireless network; and
tracking and displaying the locations of the devices.

14. The method of claim 13, further comprising displaying the tracked locations.

15. A mobile unit, comprising:
a processor;
a transceiver coupled to the processor and configured to receive location information about a remote target device;
a location determining unit coupled to the processor and configured to determine a location of the mobile unit; and
a sensing unit coupled to the processor, said sensing unit comprising:
a movement sensing circuit that is configured to sense movement of the sensing unit; and
a direction sensing circuit configured to sense a heading of the sensing unit,
wherein the processor is configured to identify the remote target device based on a heading sensed by the direction sensing circuit, a first movement sensed by the movement sensing circuit, and location information about the remote target device and mobile unit.

16. The mobile unit of claim 15, further comprising memory coupled to the processor and storing at least one command, each of which is associated with characteristics of a gesture of a gestural language set.

17. The mobile unit of claim 16, wherein, after identification of the remote target device, the processor is configured to select a command stored in the memory and transmit the selected command to the identified remote target device, wherein the selection is based on a second movement sensed by the sensing unit.

18. The mobile unit of claim 15, wherein the sensing unit is coupled to the processor by a radio link.

19. The mobile unit of claim 15, wherein the movement sensing circuit comprises at least one of an accelerometer and a gyroscope.

20. The mobile unit of claim 15, wherein the direction sensing circuit comprises an electric compass.

21. The mobile unit of claim 15, wherein the sensing unit comprises at least one of a garment and glove.

22. The mobile unit of claim 15, wherein the location determining unit is configured to determine the location of the mobile unit based on GPS signals received from a plurality of space based satellites, and the processor is configured to track the locations of the mobile unit and other remote target devices.

23. The mobile unit of claim 22, further comprising a display, wherein the processor is configured to display the locations of the tracked mobile unit and other remote target devices.

24. The mobile unit of claim 17, wherein the transmitted command comprises at least one of a text message for display by the target, an audio message to be played by the target device, and data for controlling the remote target device.

25. The mobile unit of claim 17, wherein the transmitted command comprises a peer-to-peer transmission.
